(19) United States
(12) Patent Application Publication
(10) Pub. No.: US 2023/0170636 A1
(43) Pub. Date: Jun. 1, 2023

(54) FLOATING SOCKET CONNECTOR

(71) Applicant: Molex, LLC, Lisle, IL (US)

(72) Inventors: Weihong ZHANG, Lisle, IL (US); Chiuming LU, Lisle, IL (US); Robert PISZCZOR, LaGrange, IL (US)

(73) Assignee: Molex, LLC, Lisle, IL (US)

(21) Appl. No.: 17/920,405

(22) PCT Filed: Apr. 30, 2021
(86) PCT No.: PCT/IB2021/053633

§ 371 Date: Oct. 21, 2022

Related U.S. Application Data
(60) Provisional application No. 63/018,829, filed on May 1, 2020.

(51) Int. Cl. H01R 12/91; H01R 13/11; H01R 12/71; H01R 12/70

(52) U.S. Cl. CPC H01R 12/91; H01R 12/716; H01R 12/7076; H01R 13/111

(57) ABSTRACT

A socket connector includes a base formed of a conductive upper base part and a conductive lower base part which are affixed together, a conductive barrel seated within a passageway and a pocket formed by the base, at least one conductive biasing member engaging the base and the barrel, a conductive contact seated within the barrel, and an insulative housing in which the base is positioned. The housing is coupled to the base. At least one of the upper and lower base parts has a plurality of pins depending from the respective wall which seat within plated through holes of a printed circuit board. A coupling pin is mounted in the socket connector and is further coupled to an electrical component.

### RELATED APPLICATIONS

This application claims priority to U.S. Provisional Application No. 63/018,829, filed May 1, 2020, which is incorporated herein by reference.

### FIELD OF THE DISCLOSURE

This disclosure relates to the field of connectors, more specifically to board mounted and bus mounted power connectors.

### DESCRIPTION OF RELATED ART

Power connectors are used in equipment consuming high amounts of power and consequently utilize high current. In some instances, multiple connectors are mounted on printed circuit boards and bus bars in an array. In larger arrays of power connectors, alignment of a male pin to a female socket connector may be difficult due to a buildup of tolerances. High power systems can also generate heat and the resultant expansion of the system when carrying high current can cause relative movement between the male pin and the female socket connector.

### BRIEF SUMMARY

According to an embodiment of the disclosure, a socket connector includes a base formed of a conductive upper base part and a conductive lower base part which are affixed together, a conductive barrel seated within a passageway and a pocket formed by the base, at least one conductive biasing member engaging the base and the barrel, a conductive contact seated within the barrel, and an insulative housing in which the base is positioned. The housing is coupled to the base. At least one of the upper and lower base parts has a plurality of pins depending from the respective wall which seat within plated through holes of a printed circuit board. A coupling pin is mounted in the socket connector and is further coupled to an electrical component.

To better understand the above-described objectives, characteristics and advantages of the present disclosure, embodiments, with reference to the drawings, are provided for detailed explanations.

### BRIEF DESCRIPTION OF THE DRAWINGS

The present disclosure is illustrated by way of example and not limited in the accompanying figures in which like reference numerals indicate similar elements and in which:

FIG. 1 depicts a top perspective view of an embodiment of a socket connector;

FIG. 2 depicts a bottom perspective view of the socket connector;

FIG. 3 depicts a bottom plan view of the socket connector;

FIG. 4 depicts an exploded perspective view of the socket connector;

FIG. 5 depicts a cross-sectional view of the socket connector along line 5-5 of FIG. 3; and

FIG. 6 depicts a cross-sectional view of two socket connectors mounted to a printed circuit board and to a component, such as bus bars, printed circuit boards and flexible circuits, by a pin.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as top, upper, bottom, lower, vertical and the like are used for ease in explanation, and do not denote a required orientation in use.

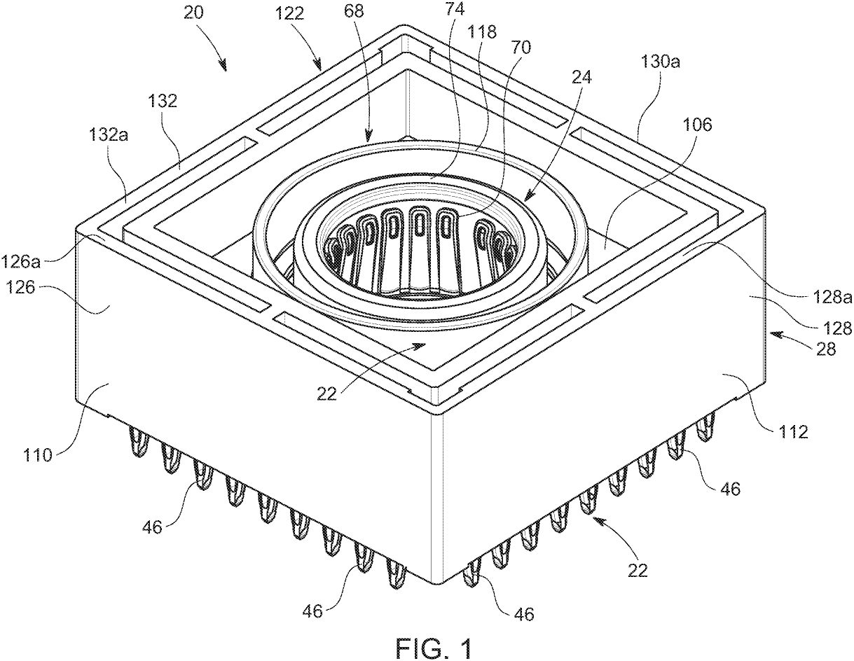

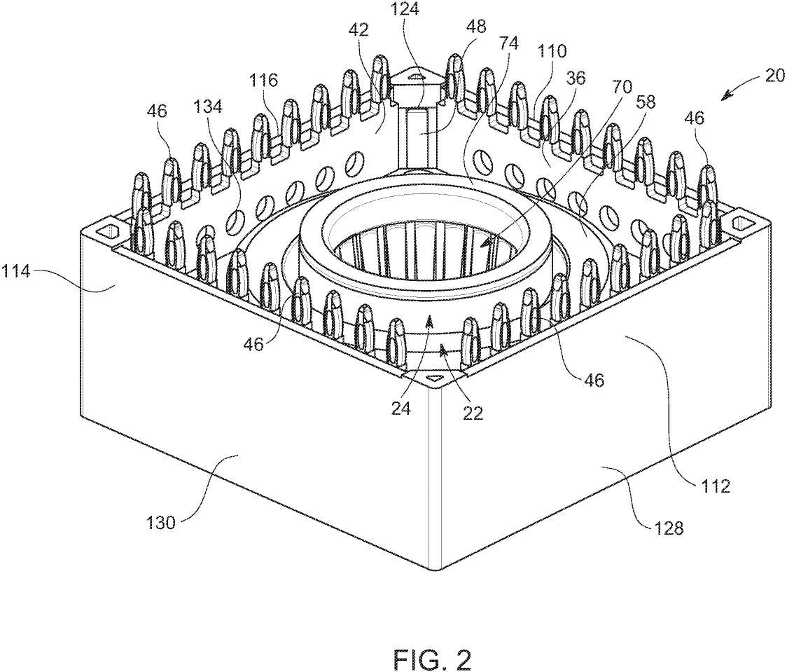

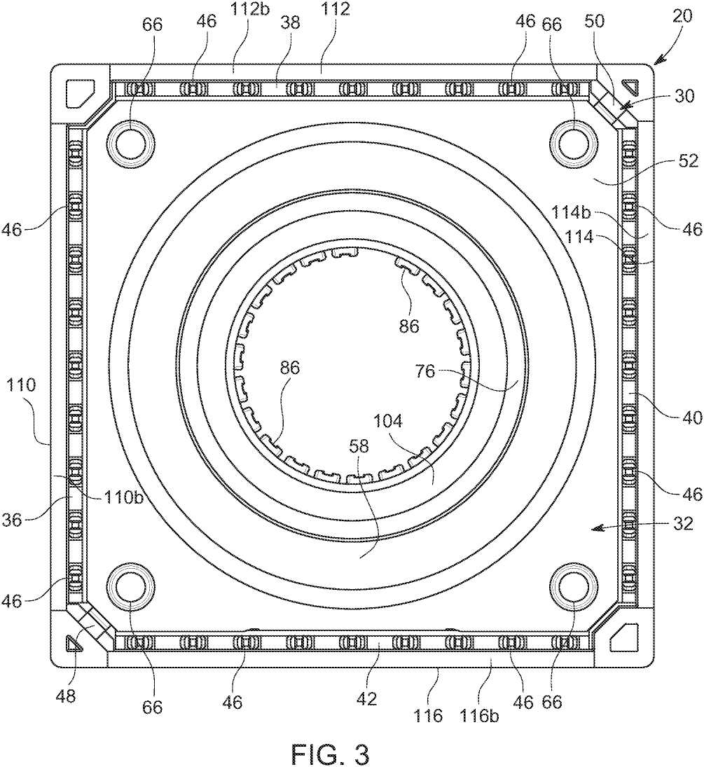

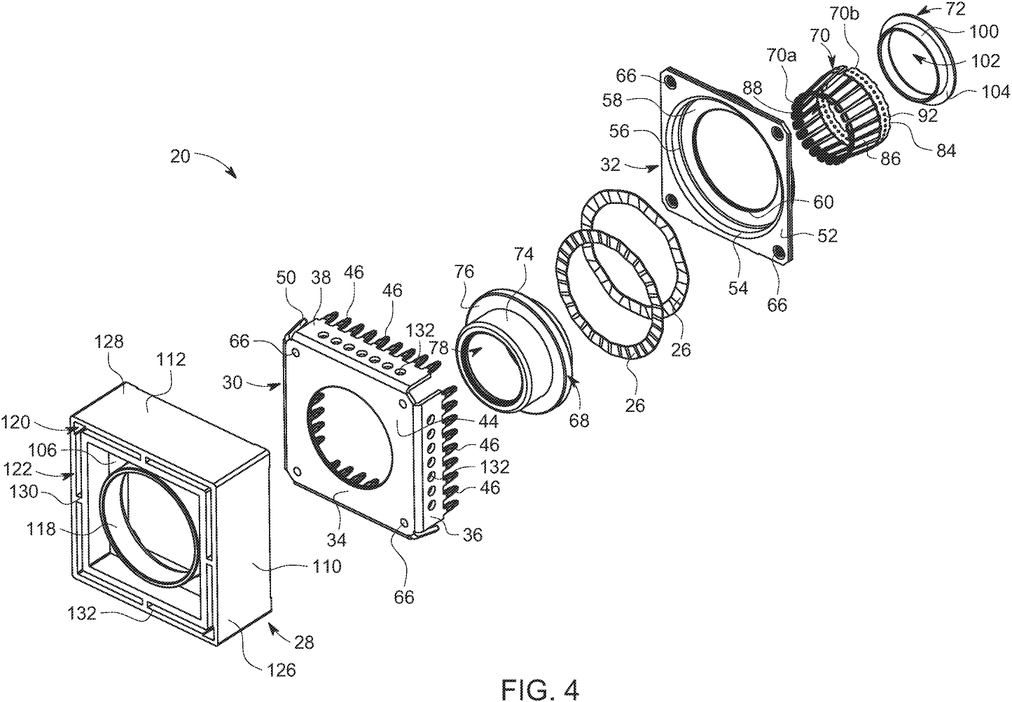

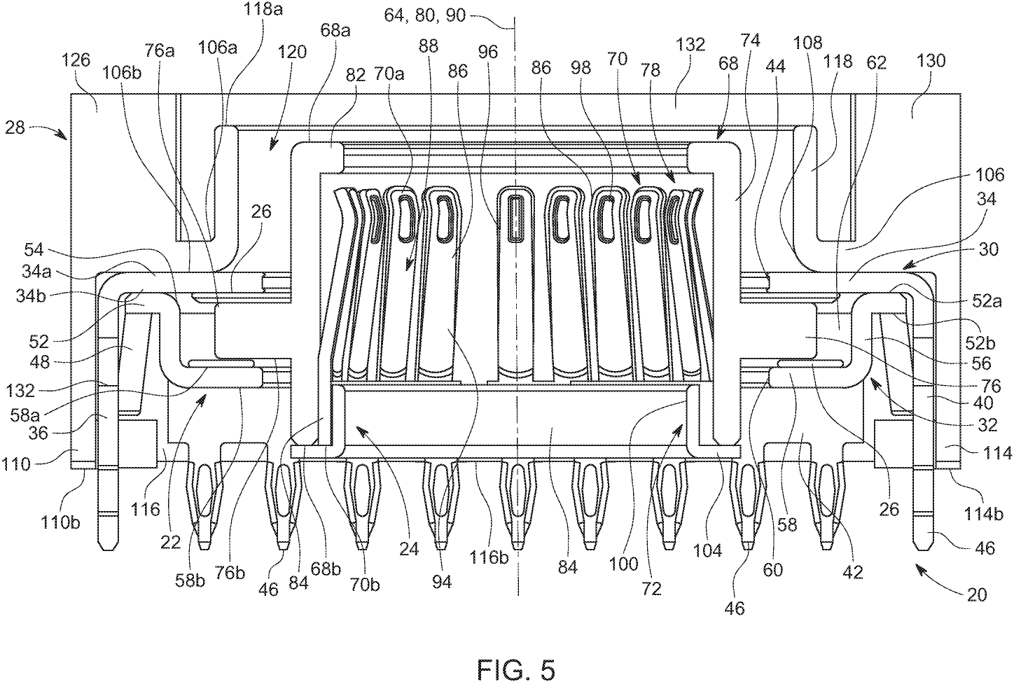

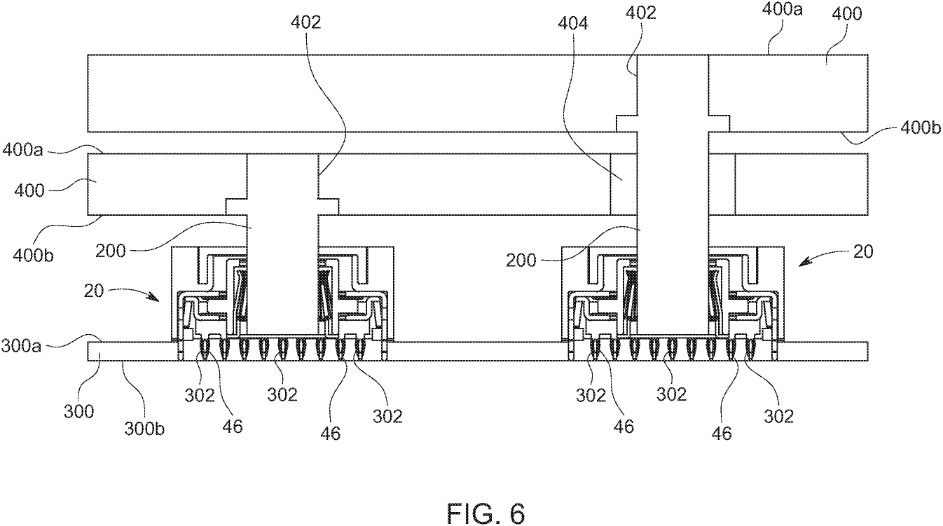

A floating socket connector 20, see FIGS. 1-5, when used with an electrical component 200, such as, for example, a coupling pin, mounted within the socket connector 20, connects another electrical component 300, such as, for example, a printed circuit board, to another electrical component 400, such as, for example, a bus bar, a printed circuit board, or a flex circuit, to form an electrical connection, see FIG. 6. In an embodiment, the socket connector 20 is a power connector. As can be appreciated from the figures, the socket connector 20 provides a floating connection configuration. By “floating connection configuration”, this means that the socket connector 20 and the coupling pin 200 can move relative to each other. This floating design allows a certain degree of misalignment between the socket connector 20 and the coupling pin 200 and the socket connector 20 automatically compensates for the misalignment while maintaining electrical contact.

The coupling pin 200 is conventional and is formed of a body having opposite ends and an outer surface which defines an outer diameter. A centerline of the coupling pin 200 is provided along the length of the coupling pin 200 between the ends and defines a longitudinal axis.

The printed circuit board 300 is conventional. The printed circuit board 300 has upper and lower surfaces 300a, 300b, and in an embodiment, the upper and lower surfaces 300a, 300b are planar. A plurality of spaced apart plated through holes 302 are provided through the printed circuit board 300 and are connected to circuitry in the printed circuit board 300 as is known in the art.

The electrical components 400 are conventional. Each electrical component 400 has upper and lower surfaces 400a, 400b which has an aperture 402 therethrough. In an embodiment, the upper and lower surfaces 400a, 400b are planar.

The socket connector 20 includes a conductive first member or base 22, a conductive contact assembly 24 mounted to the base 22, at least one conductive biasing member 26 mounted between the base 22 and the contact assembly 24, and an insulative housing 28. The base 22, the contact assembly 24, and the at least one conductive biasing member 26 are formed of a conductive material, such as metal. The insulative housing 28 may be formed of plastic. The base 22 is affixed to the printed circuit board 300 as described herein. The contact assembly 24 is configured to move relative to the base 22 and thus, relative to the printed circuit board 300 to which the base 22 is affixed.

The base 22 includes an upper base part 30 and a lower base part 32 which are affixed together.

In an embodiment as shown, the upper base part 30 has a wall formed of an upper wall portion 34 having planar upper and lower surfaces 34a, 34b, and side wall portions 36, 38, 40, 42 depending from outer edges of the upper wall portion 34 and which are perpendicular thereto. A central opening 44 extends through the upper wall portion 34 from the upper surface 34a to the lower surface 34b. Side wall portions 36, 40 are parallel to each other, and side walls 38, 42 are parallel to each other and perpendicular to side wall portions 36, 40. As shown, each side wall portion 36, 38, 40, 42 does not extend the full length of the edge of the upper wall portion 34 such that gaps are provided therebetween. Each side wall portion 36, 38, 40, 42 has a plurality of spaced apart pins 46 extending from a bottom edge thereof. In an embodiment, each pin 46 is a compliant pin or a peg. In an embodiment, some of the pins 46 are combination compliant pins and some of the pins 46 are pegs. A locking tab 48 depends from a corner of the upper wall portion 34, is provided in the gap between the side wall portions 36, 42, is angled relative to the side wall portions 36, 42, and is angled relative to the upper wall portion 34. A locking tab 50 depends from a corner of the upper wall portion 34, is provided in the gap between the side walls 38, 40, is angled relative to the side walls 38, 40, and is angled relative to the upper wall portion 34. Each locking tab 48, 50 extends at an outward angle from the upper wall portion 34. As shown, the locking tabs 48, 50 are diametrically opposed to each other and are angled relative to each other. A like locking tab 48 may also be provided between side wall portions 36 and 38 and/or between side walls 40 and 42.

In an embodiment as shown, the lower base part 32 has a wall formed from an upper wall portion 52 having a planar upper surface 52a and an opposite lower surface 52b, a central opening 54 in the upper wall portion 52 extending from the upper surface 52a to the lower surface 52b, an annular side wall portion 56 depending from a lower surface of the upper wall portion 52 around the central opening 54, and an annular wall portion 58 having a planar upper surface 58a and an opposite lower surface 58b and which extends inward from the lower edge of the side wall portion 56. The annular wall portion 58 is parallel to the upper wall portion 52 and has a central opening 60 therein which extends from the upper surface 58a to the lower surface 58b. The lower base part 32 generally forms a cup-shape.

The lower base part 32 sits within the upper base part 30. The upper surface 52a of the upper wall portion 52 of the lower base part 32 engages against the lower surface 34b of the upper wall portion 34 of the upper base part 30. The lower wall portion 58 of the lower base part 32 is parallel to the upper wall portion 34 of the upper base part 30, but is spaced therefrom by the side wall portion 56 such that a pocket 62 is formed by the wall portions 34, 56, 58. The openings 44, 60 align with each other to form a passageway through the base 22, and the centers of the openings 44, 60 define a centerline 64 of the base 22 and defines a longitudinal axis. After the contact assembly 24 and the at least one conductive biasing member 26 are positioned within the pocket 62 as described herein, the wall portions 34, 52 are permanently affixed to each other at a connection 66, such as by a mechanical connection, for example rivets, dimples seating within pockets, tabs extending through apertures and bent over, etc., by welding, electrical adhesive, a combination thereof, and the like.

The contact assembly 24 includes a conductive second member or barrel 68, a conductive contact 70 and a conductive cap 72.

The barrel 68 is formed of a vertical wall 74 and a flange 76 having planar upper and lower surfaces 76a, 76b extending outwardly from an outer surface of the vertical wall 74. An inner surface of the wall 74 forms a passageway 78 which extends from an upper end 68a of the barrel 68 to a lower end 68b of the barrel 68. A centerline 80 of the barrel 68 is provided along the length of the barrel 68 between the ends 50a, 50b thereof and defines a longitudinal axis. In some embodiments, the wall 74 and the flange 76 have a circular cross-section. The flange 76 can be provided at any position along the outer surface of the wall 74. As shown in the drawings, the flange 76 is provided proximate to, but spaced from, the lower end 68b of the barrel 68. In some embodiments, the upper surface 76a of the flange 76 may be flush with the upper end 68a of the barrel 68. In some embodiments, the lower surface 76b of the flange 76 may be flush with the lower end 68b of the barrel 68. In some embodiments, a flange 82 extends inwardly from an inner surface of the wall 74, is spaced from the flange 76, and restricts the passageway 78. In an embodiment, the flange 82 extends inwardly from the wall 74 at the upper end 68a of the barrel 68, thereby restricting an upper end of the passageway 78. In some embodiments, the flange 82 is annular. The flange 82 may be eliminated.

The contact 70 generally forms a hollow shape which generally conforms to the shape of the inner surface of the wall 74 of the barrel 68. The contact 70 may be formed of an alloy with gold plating. In an embodiment, the contact 70 is formed from a ring-like connecting portion 84 having a plurality of separate flexible beams 86 cantilevered therefrom such that a passageway 88 is formed therein which extends from an upper end 70a of the contact 70 to a lower end 70b of the contact 70. A centerline 90 of the contact 70 is provided along the length of the contact 70 between the ends 70a, 70b and defines a longitudinal axis.

The connecting portion 84 has upper and lower ends, an inner surface and an outer surface. In an embodiment, the connecting portion 84 is discontinuous around its circumference such that a slot is provided. In some embodiments, the connecting portion 84 has a plurality of spaced apart inwardly extending protrusions 92 and outwardly extending protrusions 92 provided thereon. The inwardly and outwardly extending protrusions 92 may be aligned around the circumference of the connecting portion 84. The inwardly and outwardly extending protrusions 92 may alternate between a protrusion extending outwardly from the outer surface of the connecting portion 84 and a protrusion extending inwardly from the inner surface of the connecting portion 84. The connecting portion 84 may have a plurality of nubs extending therefrom.

The beams 86 extend from the first end of the connecting portion 84. Each beam 86 is parallel to, and radially spaced from, the centerline 90. The beams 86 are spaced apart from each other around the circumference of the connecting portion 84. In an embodiment, each beam 86 has a first portion 94 which extends at an angle from the connecting portion 84 at a corner, and a second portion 96 which extends at an angle from an end of the first portion 94 at a corner. The first portion 94 angles inwardly toward the centerline 90, and the second portion 96 angles outwardly from the centerline 90. The corners between the first and second portions 94, 96 may be radiused. In an embodiment, the corners between the first and second portions 94, 96 are aligned around the circumference of the contact 70 and define an inner diameter. The inner diameter defined by the corners between the first and second portions 94, 96 is less than the diameter of the coupling pin 200. In an embodiment, each beam 86 has a recess 98 along its inner surface which is spaced from the free end of the second portion 96. The contact 70 may be stamped out of a flat sheet of material and rolled into the shape. The contact 70 may be machined into the shape.

In an embodiment, the cap 72 has an annular first wall 100 which defines a central passageway 102, and a second wall 104 extending radially outwardly from and perpendicular to the first wall 100.

The contact 70 is seated within the passageway 78 of the barrel 68 such that the upper end 70a of the contact 70 does not protrude from and is spaced from the upper end 68a of the barrel 68, the lower end 70b of the contact 70 generally aligns with the lower end 68b of the barrel 68, and the centerlines 80, 90 align. The outer surface of the connecting portion 84 is proximate to the inner surface of the wall 74 of the barrel 68 and the outwardly extending protrusions 92 abut against the inner surface of the wall 74. The cap 72 secures the barrel 68 and the contact 70 together. In an embodiment, the cap 72 is press fit to the barrel 68 and contact 70. In an embodiment, the cap 72 is crimped to the barrel 68 and contact 70. The wall 100 of the cap 72 engages against the inwardly extending protrusions 92 of the barrel 68. The wall 100 of the cap 72 has a diameter which is less than a diameter defined by the inwardly extending protrusions 92. Therefore, when the wall 100 of the cap 72 is engaged with the connecting portion 84, the protrusions 92 are deformed. The wall 104 engages the end 68b of the wall 74 of the barrel 68 and may engages the end of the connecting portion 84. In some embodiments, the ends of the nubs on the connecting portion 84 engage against the wall 104 and form electrical paths. In an embodiment, the cap 72 is not provided and the contact 70 is secured within/to the barrel 68 by other means.

In an embodiment, the biasing member(s) 26 are wave springs. In an embodiment, the biasing member(s) 26 are spring washers. In an embodiment, the biasing member(s) 26 are thrust washers.

The contact assembly 24 and the biasing members 26 seat within the base 22. Since the base 22 is formed of two base parts 30, 32 which are affixed together, seating of the contact assembly 24 and the biasing members 26 economical. In a first method of seating, the first biasing member 26 is seated against the upper surface 58a of the wall portion 58 of the lower base part 32 and surrounds the opening 60. Thereafter, the flange 76 is positioned on top of the first biasing member 26 such that the lower surface 76b engages the first biasing member 26, and the wall 74 extends through the opening 60. The second biasing member 26 is then seated on the upper surface 76a of the flange 76 and surrounds the flange 76. Next, the upper base part 30 is seated on top of the second biasing member 26 with the lower surface 34b of the wall portion 34 engaging the second biasing member 26 and the upper surface 52a of the wall portion 52, and the wall 74 extends through the opening 44. Thereafter, the base parts 30, 32 are affixed together at the connection 66. Alternatively, in a second method of seating, the order of assembly is reversed and the base parts 30, 32 are thereafter affixed together at the connection 66. As such, the wall 74 of the barrel 68 seats within the openings 44, 60 of the base 22 and the flange 76 seats within the pocket 62 of the base 22. The wall 74 extends upwardly from the wall portion 52 and downwardly from the wall portion 58. The lower end of the contact assembly 24 is parallel to, or slightly above, the lower ends of the side wall portions 36, 38, 40, 42 and upward of the upper ends of the pins 46. The wall 74 has a diameter which is less than the openings 44, 60 of the base 22 and the flange 76 is smaller than the pocket 62 of the base 22 but has a diameter which is greater than the openings 44, 60 of the base 22. The first biasing member 26 is seated within the pocket 62 and between, and abuts, the flange 76 and the wall portion 58 and further surrounds the wall 74 of the barrel 68, and the second biasing member 26 is seated within the pocket 62 and between, and abuts, the flange 76 and the wall portion 34 and further surrounds the wall 74 of the barrel 68. In an embodiment, only the first biasing member 26 is provided and the flange 76 engages the wall portion 34. In an embodiment, only the second biasing member 26 is provided and the flange 76 engages the wall portion 58. The contact assembly 24 can move relative to the base 22, but cannot be pulled outwardly from the base 22.

The assembled base 22, contact assembly 24 and biasing member(s) 26 seat within the insulative housing 28. The insulative housing 28 has a base wall 106 having an upper surface 106a, a planar lower surface 106b and a central opening 108 therethrough, side walls 110, 112, 114, 116 depending downward from outer edges of the base wall 106 and which are perpendicular thereto, and a central wall 118 extending up from the upper surface 106a and surrounding the central opening 108. Each side wall 110, 112, 114, 116 has a lower end 110b, 112b, 114b, 116b. The central wall 118 has an upper end 118a and forms a passageway 120 which aligns with the central opening 108. Side walls 110, 114 are parallel to each other, and side walls 112, 116 are parallel to each other and perpendicular to side walls 110, 114. A recess 124 is formed at the junction between side walls 110 and 116 and at the junction between side walls 112, 114. A recess 124 may also be formed at the junction between side walls 110 and 112 and at the junction between side walls 114 and 116 if additional locking tabs 48 are provided. When the assembled base 22, contact assembly 24 and biasing member(s) 26 are seated within the insulative housing 28, the upper surface 34a of the wall portion 34 of the upper base part 30 abuts against the lower surface 106b of the base wall 106 of the insulative housing 28, and the locking tabs 48 snap into and seat within the recesses 124 to prevent the assembled base 22, contact assembly 24 and biasing member(s) 26 from exiting the insulative housing 28. The outer surfaces of the side wall portions 36, 38, 40, 42 are proximate to, and may abut against, the inner surfaces of the side walls 110, 112, 114, 116, and the pins 46 extend downward from the lower ends 110b, 112b, 114b, 116b of the side walls 110, 112, 114, 116. The portion of the wall 74 and the portion of the contact 70 which extend upward from the wall portion 34 pass through the central opening 108 and are positioned within the passageway 120 of the central wall 118. The upper end 68a of the barrel 68 does not protrude upward from the upper end 118a of the central wall 118. While the locking tabs 48 are described as extending from the upper base part 30 and the recesses 124 being provided in the insulative housing 28, the locking tabs 48 can extend from the insulative housing 28 and the recesses 124 being provided in the upper base part 30. In addition, while locking tabs 48 and recesses 124 are shown and described, other forms of attaching the assembled base 22, contact assembly 24 and biasing member(s) 26 to the insulative housing 28 are within the scope of the present disclosure.

The socket connector 20 is mounted to the printed circuit board 300 by press fitting the pins 46 into the plated through holes 302. The lower ends 110b, 112b, 114b, 116b of the side walls 110, 112, 114, 116 of the insulative housing 28 seat against the upper surface 300a of the printed circuit board 300. When the pins 46 are press fit into the plated through holes 302, the contact assembly 24 can move relative to the base 22 and relative to the printed circuit board 300, but the base 22 and the insulative housing 28 cannot move relative to the printed circuit board 300. As a result, the socket connector 20 is easily mounted to the printed circuit board 300.

The coupling pin 200 is inserted into the contact 70 through the passageway 120 and then through the passageway 78 and into the contact 70. The coupling pin 200 first passes the free ends of the beams 86 and then engages with the corners between the first and second portions 94, 96 of the contact 70. When the coupling pin 200 engages with the corners between the first and second portions 94, 96 of the contact 70, the beams 86 flex and generally straighten. Electrical signals flow from the coupling pin 200, through the beams 86, through the connecting portion 84, though the barrel 68 and the cap 72, through the biasing member(s) 26, through the base 22 to the printed circuit board 300. When inserting the coupling pin 200 into the passageway 120, the coupling pin 200 may first contact the upper end 118a of the central wall 118 which causes the coupling pin 200 to self-center and move radially inward toward the wall 74. The upper end 118a of the central wall 118 may be beveled to promote this movement.

The flange 76 of the barrel 68 can translate in a radial direction and rotate within the pocket 62 of the base 22. The biasing member(s) 26 bias the flange 76 against the opposing wall portion 34, 58 to maintain electrical contact between the flange 76 and the base 22, and consequently with the contact 70. Since the contact assembly 24 can move relative to the base 22, a certain degree of misalignment between the socket connector 20 and the coupling pin 200 is automatically compensated for, while maintaining electrical contact. When misaligned, the centerline of the coupling pin 200 does not align with the centerline 64 of the base 22 during insertion. If there is misalignment, the contact assembly 24 moves or floats by the flange 76 engaging with the biasing member(s) 26 to compress the biasing member(s) 26. In this regard, if two biasing members 26 are provided in the form of springs, the springs may have different spring characteristics to provide for a stiffer spring and a softer spring. The softer spring deflects first to provide tolerance and after the softer spring is deflected, the stronger spring deflects to provide tolerance. For example, if wave springs are provided, one wave spring may have more waves than the other wave spring. For example, one wave spring may have twelve waves, while the other wave spring has six waves. In a preferred embodiment, the stiffer spring has double the waves of the softer spring.

In an embodiment, the printed circuit board 300 has a through hole (not shown) therethrough above which the floating socket connector 20 is mounted. In this embodiment, the lower portion of the wall 74 of the barrel 68 may extend downward from the lower ends 110b, 112b, 114b, 116b of the side walls 110, 112, 114, 116 such that the barrel 68 is positioned within the through hole the printed circuit board 300. The barrel 68 has a diameter which is less than the diameter of the through hole 302 in the printed circuit board 300. When the pins 46 are press fit into the plated through holes 302, the contact assembly 24 can move relative to the base 22 and relative to the pocket 62 and the printed circuit board 300, but the base 22 and the insulative housing 28 cannot move relative to the pocket 62 and the printed circuit board 300. In this embodiment, the coupling pin 200 can be inserted into the contact 70 through the passageway 120 as described herein, or can be inserted into the contact 70 through the through hole 302 in the printed circuit board 300.

In an embodiment, the contact assembly 24 and the biasing member(s) 26 are assembled to the base 22 in a position flipped 180 degrees from that shown in the drawings. If a through hole is not provided through the printed circuit board 300, the lengths of the side walls 110, 112, 114, 116 are increased such that the ends 68a of the barrel 68 are above the upper surface 300a of the printed circuit board 300, or the flange 76 is positioned on the wall 74 closer to the end 68a (now bottom end in the orientation as shown in the drawings) of the barrel 68. In this embodiment, if the through hole is not provided through the printed circuit board 300, the coupling pin 200 is inserted into the contact 70 through the passageway 120 and then through the passageway 78 and into the contact 70 to engage with the beams 86 as described herein. In this embodiment, if the through hole in the printed circuit board 300 is provided, the coupling pin 200 can be inserted into the contact 70 through the passageway 120 as described herein, or can be inserted into the contact 70 through the through hole in the printed circuit board 300.

An example of an implementation of the socket connector 20 with the printed circuit board 300 and first and second electrical components 400 is shown in FIG. 6. Each coupling pin 200 seats within the aperture 402 of, and is secured to, a respective one of the electrical components 400 and is electrically isolated from the other one of the respective electrical components 400 by an electrical isolator 404. Examples of electrical isolators 404 are insulative members or air gaps. Each coupling pin 200 is received in a respective socket connector 20 mounted on the printed circuit board 300 and makes electrical contact with the socket connector 20 as described herein. The contact assembly 24 moves relative to the base 22, the insulative housing 28 and the printed circuit board 300 to compensate for any tolerance stack. Movement resulting from expansion caused by the generation of heat can also be absorbed by the float between the contact assembly 24 and the base 22.

In an embodiment as shown in the drawings, the insulative housing 28 further has a second wall 122 extending upward from the upper surface 106a of the base wall 106, which is spaced from the central wall 118. In an embodiment, the upper end 118a of the central wall 118 does not protrude outward from the second wall 122 and is spaced from the upper end of the second wall 122. As shown, the second wall 122 has a first wall portion 126 extending upward from the upper surface 106a and which aligns with the wall 110, a second wall portion 128 extending upward from the upper surface 106a and which aligns with the wall 112, a third wall portion 130 extending upward from the upper surface 106a and which aligns with the wall 114, and a fourth wall portion 132 extending upward from the upper surface 106a and which aligns with the wall 116. An upper end 126a, 128a, 130a, 132a of each wall portion 126, 128, 130, 132 is planar and falls in the same plane. The wall portions 126, 128, 130, 132 may have a double thickness with ribbing therebetween as shown, may have a single thickness, or may take on any varieties of shapes, provided each wall portion 126, 128, 130, 132 has a surface on its upper end 126a, 128a, 130a, 132a that is planar and falls in the same plane. Side walls 126, 130 are parallel to each other, and side walls 128, 132 are parallel to each other and perpendicular to side walls 126, 130. When a flat rock tool (not shown), such as a flat piece of steel, is engaged against the planar portion of the upper end of each wall portion 126, 128, 130, 132, an even application of pressure is applied to the pins 46 as the pins 46 are easily press fit into the printed circuit board 300. As a result, a special tool is not needed to attach the socket connector 20 to the printed circuit board 300 and the same tool can be used to assemble multiple sizes of the socket connector 20 with the printed circuit board 300. In an embodiment, the second wall 122 is circular. As discussed above, the coupling pin 200 is inserted into the contact 70 through the passageway 120 and then through the passageway 78 and into the contact 70. When inserting the coupling pin 200 into the passageway 120, the coupling pin 200 may first contact the upper end 126a, 128a, 130a, 132a of one or more of the wall portions 126, 128, 130, 132 which causes the coupling pin 200 to move radially inward toward the central wall 118. The coupling pin 200 may then contact the upper end 118a of the central wall 118 which causes the coupling pin 200 to move radially inward toward the wall 74. The upper ends 126a, 128a, 130a, 132a of the wall portions 126, 128, 130, 132 and/or the upper end 118a of the central wall 118 may be beveled to promote these movements.

As an alternative, the upper end 118a of the central wall 118 protrudes outward from the second wall 122. In this embodiment, the flat rock tool is modified to have an opening therethrough or recess therein which accommodates the wall 74. This, however, causes the assembler to have multiple tools for assembling different sized of socket connectors 20 with printed circuit boards 300.

In an embodiment, vertical wall portions and pins, like side wall portions 36, 38, 40, 42 having pins 46, extend downward from the wall portion 52 and/or wall portion 58 and mate with a plurality of spaced apart plated through holes (not shown) provided through the printed circuit board 300. In an alternate embodiment, the vertical wall portions and pins, like side wall portions 36, 38, 40, 42 having pins 46, only extend downward from the wall portion 52 and/or wall portion 58, and do not extend downward from the upper wall portion 34.

In an embodiment, the central wall 118 has a flange (not shown) which extends perpendicular thereto to make the socket connector 20 touch-safe.

In an embodiment as shown in the drawings, the side wall portions 36, 38, 40, 42 of the upper base part 30 have a plurality of spaced apart air holes 134 therethrough which provides for air flow therethrough to dissipate heat. In an embodiment, the outer surfaces of the side wall portions 36, 38, 40, 42 are spaced from the inner surfaces of the side walls 110, 112, 114, 116 to provide an air flow gap therebetween to allow air to flow through the air holes 134 and into the air flow gap. Alternatively, or in addition thereto, the side walls 110, 112, 114, 116 of the insulative housing 28 have holes (not shown) therethrough. If the side wall portions 36, 38, 40, 42 of the upper base part 30 abut against the side walls 110, 112, 114, 116 of the insulative housing 28, the holes through the insulative housing 28 align with the air holes 134 in the upper base part 30. If the side wall portions 36, 38, 40, 42 of the upper base part 30 do not abut against the side walls 110, 112, 114, 116 of the insulative housing 28, the holes through the insulative housing 28 may align with the air holes 134 in the upper base part 30 or may be offset therefrom.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Finally, the drawings are not necessarily drawn to scale.

1. A socket connector configured to be mounted to a printed circuit board, comprising:
a base formed of a conductive upper base part and a conductive lower base part, each base part having a wall, the walls of the upper and lower base parts being affixed together and forming a pocket therebetween and a passageway therethrough, wherein at least one of the upper and lower base parts has a plurality of pins depending from the respective wall;
a conductive barrel including a wall, a passageway extending between opposite ends of the wall of the barrel, and a flange extending outwardly from the wall of the barrel, the wall of the barrel being positioned within the passageway formed by the base and the flange being positioned within the pocket, wherein the barrel is configured for movement within the pocket and the passageway formed by the base;
at least one conductive biasing member engaging the flange and the base, and surrounding the wall of the barrel;
a conductive contact seated within the passageway of the barrel; and
an insulative housing having a passageway therethrough, the base being positioned within the passageway of the insulative housing, and the insulative housing being coupled to the base.

2. The socket connector of claim 1, wherein the plurality of pins depend from the respective wall of the base and extend downward from a lower end of the insulative housing.

3. (canceled)

4. The socket connector of claim 1, wherein each pin is a compliant pin.

5. The socket connector of claim 1, wherein the insulative housing comprises a base wall having an opening therethrough through which the barrel passes, a first wall extending from an upper surface of the base wall and surrounding an upper end portion of the wall of the barrel, the first wall extending from the base wall being spaced from the wall of the barrel.

6. The socket connector of claim 5, wherein the wall of the barrel does not protrude outwardly from the first wall.

7. The socket connector of claim 5, wherein the insulative housing further comprises a second wall extending from the upper surface of the base wall and surrounding the first wall, the second wall being spaced from the first wall, the second wall having at least one planar surface against which a tool can be pressed, wherein the first wall does not protrude outward from the second wall.

8. (canceled)

9. The socket connector of claim 1, wherein the walls of the upper and lower base parts are affixed together by at least one of mechanical connection, welding, and electrical adhesive.

10. The socket connector of claim 1, wherein the insulative housing is coupled to the base by locking tabs extending from one of the upper base part and the insulative housing which is seated within recesses in the other of the of the upper base part and the insulative housing.

11. The socket connector of claim 1, wherein at least one conductive biasing member is a wave spring.

12. The socket connector of claim 1, further comprising a cap coupling the contact to the barrel.

13. The socket connector of claim 1, wherein the contact comprises a ring-like connecting portion and a plurality of spaced apart beams cantilevered therefrom, each beam having a first portion extending from the connecting portion and a second portion extending from the first portion at a corner, the second portion being angled relative to the first portion.

14. The socket connector of claim 13, wherein each beam has a recess provided in the corner.

15. The socket connector of claim 1, wherein the contact comprises a ring-like connecting portion, a plurality of protrusions extending from the connecting portion, and a plurality of spaced apart beams cantilevered from the connecting portion.

16. The socket connector of claim 1, further in combination with a coupling pin, the coupling pin extending into the contact and contacting the contact.

17. The socket connector and coupling pin of claim 16, further in combination with a printed circuit board, the pins of the socket connector being seated within plated through holes of the printed circuit board.

18. (canceled)

19. (canceled)

20. The socket connector and coupling pin of claim 1, further in combination with a printed circuit board, the pins of the socket connector being seated within plated through holes of the printed circuit board.

21. A socket connector configured to be mounted to a printed circuit board, comprising:
a first member having opposite ends, a first passageway extending between the opposite ends, and a pocket extending outwardly from the first passageway, the first member has a plurality of pins depending therefrom;
a second member including a wall having opposite ends, a second passageway extending between the opposite ends of the wall, and a flange extending outwardly from the wall, the wall being seated within the first passageway of the first member and the flange being seated within the pocket of the first member, wherein the second member is configured for movement within the first member;
a first biasing member engaging a first side of the flange and surrounding the wall;
a second biasing member engaging a second, opposite side of the flange;
a contact seated within the second passageway of the second member; and
an insulative housing having a third passageway therethrough, the first member being positioned within the third passageway of the insulative housing, and the insulative housing being coupled to the first member.

22. The socket connector of claim 21, wherein the first member is formed of a conductive upper base part and a conductive lower base part which are affixed together and form the pocket therebetween and the passageway therethrough, wherein at least one of the upper and lower base parts has the plurality of pins depending therefrom.

23. A socket connector configured to be mounted to a printed circuit board, comprising:
a first member which is at least partially formed of a conductive material, the first member being configured to be mounted to a first electrical component, the first member has a plurality of pins depending therefrom;
a second member which is at least partially formed of a conductive material, the second member being configured to receive a second electrical component, the second member being held by the first member, the second member configured to be floatable relative to the first member;
first and second biasing member which are held within the first member, the first and second biasing members configured to maintain an electrical connection between the first member and the second member, to thereby maintain an electrical connection between the first electrical component and the second electrical component; and
an insulative housing having a passageway therethrough, the first member being positioned within the passageway of the insulative housing, and the insulative housing being coupled to the first member.

24. The socket connector of claim 23, wherein the first member is formed of a conductive upper base part and a conductive lower base part which are affixed together and form a pocket therebetween and a passageway therethrough, wherein at least one of the upper and lower base parts has the plurality of pins depending therefrom.
